(19) United States
(12) Patent Application Publication
(10) Pub. No.: US 2026/0353382 A1
(43) Pub. Date: Nov. 5, 2026

(54) MANAGING LATENCY FOR RESOURCE SELECTION AND RESELECTION IN WIRELESS COMMUNICATIONS

(71) Applicant: TOYOTA JIDOSHA KABUSHIKI KAISHA, Toyota-shi, Aichi-ken (JP)

(72) Inventors: Claude ARZELIER, Varna (BG); Nuno KIILERICH PRATAS, Gistrup (DK); Faranaz SABOURI-SICHANI, Aalborg Oe (DK); Thomas JACOBSEN, Noerresundby (DK); Takayuki SHIMIZU, Mountain View, CA (US)

(73) Assignee: TOYOTA JIDOSHA KABUSHIKI KAISHA, Toyota-shi, Aichi-ken (JP)

(21) Appl. No.: 19/102,600

(22) PCT Filed: Jul. 28, 2023
(86) PCT No.: PCT/JP2023/027690

§ 371 Date: Feb. 10, 2025

Related U.S. Application Data
(60) Provisional application No. 63/371,032, filed on Aug. 10, 2022.

(51) Int. Cl. H04W 72/12; H04W 72/0446

(52) U.S. Cl. CPC H04W 72/1215; H04W 72/0446

(57) ABSTRACT

A method, user equipment (UE), and a non-transitory computer readable medium containing instructions for adjusting at least one of a start or an end of a radio resource window at the UE are provided. The method includes determining at least one of radio resource sensing information or radio resource reservation information at a first radio access technology (RAT) module, wherein the first RAT module is configured to implement a first RAT. The determined at least one of radio resource sensing information or radio resource reservation information is sent from the first RAT module to a second RAT module, wherein the second RAT module is configured to implement a second RAT, the second RAT being different from the first RAT. A time value is determined and at least one of the start or the end of the radio resource window is adjusted by the time value.

### CROSS-REFERENCE TO RELATED PATENT APPLICATION

This application claims the benefit of priority of U.S. Provisional Patent Application No. 63/371,032, filed on Aug. 10, 2022, the entirety of which is incorporated by reference herein.

### TECHNICAL FIELD

This disclosure relates to adjusting at least one of a start or an end of a radio resource window at a user equipment (UE) in a communication network.

### BACKGROUND ART

Sidelink communication is used in 3GPP radio interfaces to allow two (or more) User Equipments (UEs) (e.g., wireless devices) to directly communicate with each other. This may happen under the coverage of a cellular network, out of coverage of the cellular network, or in partial coverage of the cellular network where only one of the two UEs is under the cellular network coverage. The device-to-device direct communication uses the PC5 interface in an example of 3GPP sidelink communication.

### SUMMARY OF INVENTION

In some embodiments, a method for adjusting at least one of a start or an end of a radio resource window at a user equipment (UE) is provided. The method includes determining at least one of radio resource sensing information or radio resource reservation information at a first radio access technology (RAT) module, wherein the first RAT module is configured to implement a first RAT. The determined at least one of radio resource sensing information or radio resource reservation information is sent from the first RAT module to a second RAT module, wherein the second RAT module is configured to implement a second RAT, the second RAT being different from the first RAT. A time value is determined and at least one of the start or the end of the radio resource window is adjusted by the time value.

In some embodiments, a user equipment (UE) for adjusting at least one of a start or an end of a radio resource window by the UE is provided. The UE includes a memory configured to store instructions and a processor configured to execute the instructions stored in the memory. The processor is configured to determine at least one of radio resource sensing information or radio resource reservation information at a first radio access technology (RAT) module, wherein the first RAT module is configured to implement a first RAT; send the determined at least one of radio resource sensing information or radio resource reservation information from the first RAT module to a second RAT module, wherein the second RAT module is configured to implement a second RAT, the second RAT being different from the first RAT; determine a time value; and adjust at least one of the start or the end of the radio resource window by the time value.

In some embodiments, a non-transitory computer-readable medium storing instructions that are executable by one or more processors of a user equipment (UE) in a communication network to perform a method is provided. The method includes determining at least one of radio resource sensing information or radio resource reservation information at a first radio access technology (RAT) module, wherein the first RAT module is configured to implement a first RAT. The determined at least one of radio resource sensing information or radio resource reservation information is sent from the first RAT module to a second RAT module, wherein the second RAT module is configured to implement a second RAT, the second RAT being different from the first RAT. A time value is determined and at least one of the start or the end of the radio resource window is adjusted by the time value.

The above and other aspects and their implementations are described in greater detail in the following descriptions in the drawings.

### BRIEF DESCRIPTION OF DRAWINGS

FIG. 1 is a schematic diagram illustrating device types for dynamic co-channel coexistence of a first sidelink communication and a second sidelink communication, consistent with some embodiments of the present disclosure.

FIG. 2 is a block diagram of a UE, consistent with some embodiments of the present disclosure.

FIG. 3 is a flowchart of a method for adjusting at least one of a start or an end of a radio resource window at a UE, consistent with some embodiments of the present disclosure.

FIG. 4 is a schematic diagram illustrating different UEs in communication with each other, consistent with some embodiments of the present disclosure.

### DESCRIPTION OF EMBODIMENTS

Reference will now be made in detail to exemplary embodiments, examples of which are illustrated in the drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of apparatuses, systems, and methods consistent with aspects related to subject matter that may be recited in the appended claims.

Generally described, one or more aspects of the present disclosure are directed to resource selection and resource reselection with user equipment (UE) autonomous sensing. Some embodiments of the present disclosure may apply specifically to related 3GPP Sidelink solutions, for example, 3GPP 5G NR-V2X PC5 mode 2 resource selection or 3GPP LTE-V2X PC5 mode 4 resource selection.

The Physical Sidelink Shared CHannel (PSSCH) carries Sidelink Data in both LTE (Long Term Evolution) Sidelink and NR (5G New Radio) Sidelink. In LTE and NR Sidelink, sensing is performed to collect resource reservation information from other UEs and measure Sidelink Reference Signal Receive Power (SL-RSRP) and Sidelink Received Signal Strength Indicator (SL-RSSI) so that the transmitting UE may determine available radio resources in the selection window.

It was proposed to expand the applicability of NR sidelink and consider the vehicle-to-everything (V2X) deployment scenario where LTE V2X and NR V2X devices co-exist in the same frequency channel. For this co-existence, some mechanism may be created to utilize resource allocations by those two technologies in an efficient way without negatively impacting the operation of each technology.

### Device Types A, B, and C

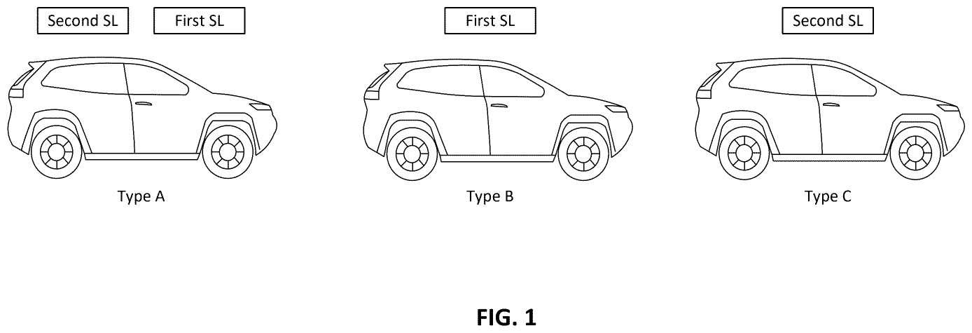

FIG. 1 is a schematic diagram illustrating device types for dynamic co-channel coexistence of a first sidelink (SL) communication and a second sidelink (SL) communication, consistent with some embodiments of the present disclosure. Referring to FIG. 1, at least three types (Type A, Type B, and Type C) of devices are considered in this disclosure. A Type A device includes a module for the first sidelink communication and a module for the second sidelink communication. A Type B device only includes a module for the first sidelink communication. A Type C device only include a module for the second sidelink communication. For example, in an embodiment, a Type A device includes both LTE SL and NR SL modules; a Type B device only includes an NR SL module; and a Type C device only includes an LTE SL module.

### User Equipment (UE)

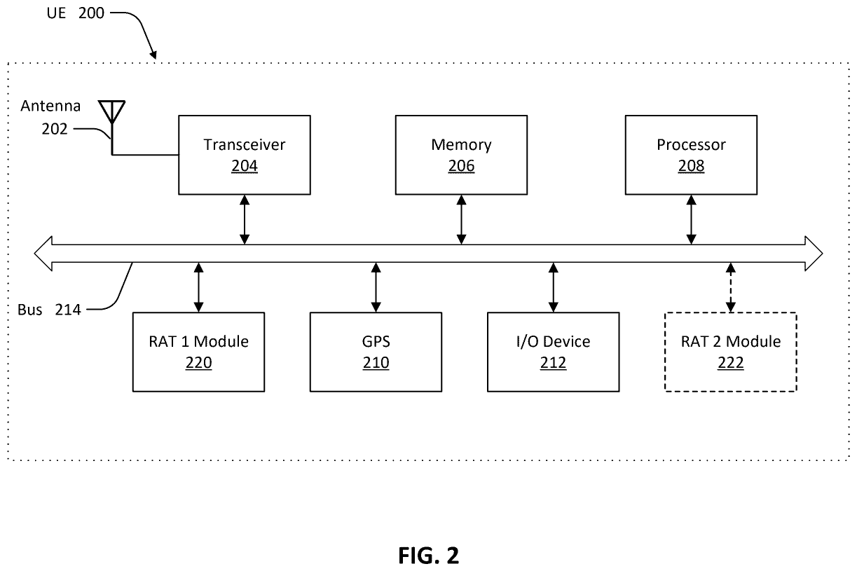

FIG. 2 is a block diagram of a UE 200, consistent with some embodiments of the present disclosure. The UE 200 may be a Type A, Type B, Type C, or any other type of UE. The UE 200 may be mounted in a moving vehicle, in a fixed position (e.g., as a roadside unit (RSU)), or may be carried by a person. The UE 200 may take any form, including but not limited to, a vehicle, a component mounted in a vehicle, an RSU, a laptop computer, a wireless terminal including a mobile phone, a wireless handheld device, a wireless personal device, or any other form. Referring to FIG. 2, the UE 200 may include an antenna 202 that may be used for transmission of electromagnetic signals to and/or reception of electromagnetic signals from a base station or other UEs. The antenna 202 may include one or more antenna elements and may enable different input-output antenna configurations, for example, multiple input multiple output (MIMO) configuration, multiple input single output (MISO) configuration, and single input multiple output (SIMO) configuration. In some embodiments, the antenna 202 may include multiple (e.g., tens or hundreds) antenna elements and may enable multi-antenna functions such as beamforming. In some embodiments, the antenna 202 is a single antenna.

The UE 200 may include a transceiver 204 that is coupled to the antenna 202. The transceiver 204 may be a wireless transceiver and may communicate bi-directionally with a base station or other UEs. For example, the transceiver 204 may receive wireless signals from a base station via downlink communication and transmit wireless signals to the base station via uplink communication. The transceiver 204 may also receive wireless signals from and transmit wireless signals to another UE or roadside unit (RSU) via sidelink communication. The transceiver 204 may include a modem to modulate the packets and provide the modulated packets to the antenna 202 for transmission and to demodulate packets received from the antenna 202.

The UE 200 may include a memory 206. The memory 206 may be any type of computer-readable storage medium including volatile or non-volatile memory devices, or a combination thereof. The computer-readable storage medium includes, but is not limited to, non-transitory computer storage media. A non-transitory storage medium may be accessed by a general purpose or special purpose computer. Examples of non-transitory storage medium include, but are not limited to, a portable computer diskette, a hard disk, random access memory (RAM), read-only memory (ROM), an erasable programmable read-only memory (EPROM), electrically erasable programmable ROM (EEPROM), a digital versatile disk (DVD), flash memory, compact disk (CD) ROM or other optical disk storage, magnetic disk storage or other magnetic storage devices, etc. A non-transitory medium may be used to carry or store desired program code means (e.g., instructions and/or data structures) and may be accessed by a general-purpose or special-purpose computer, or a general-purpose or special-purpose processor. In some examples, the software/program code may be transmitted from a remote source (e.g., a website, a server, etc.) using a coaxial cable, fiber optic cable, twisted pair, digital subscriber line (DSL), or wireless technologies such as infrared, radio, and microwave. In such examples, the coaxial cable, fiber optic cable, twisted pair, DSL, or wireless technologies such as infrared, radio, and microwave are within the scope of the definition of medium. Combinations of the above examples are also within the scope of computer-readable medium.

The memory 206 may store information related to identities of the UE 200 and the signals and/or data received by the antenna 202. The memory 206 may also store post-processing signals and/or data. The memory 206 may also store computer-readable program instructions, mathematical models, and algorithms that are used in signal processing in transceiver 204 and computations in a processor 208. The memory 206 may further store computer-readable program instructions for execution by the processor 208 to operate UE 200 to perform various functions described elsewhere in this disclosure. In some examples, the memory 206 may include a basic input/output system (BIOS) which may control basic hardware or software operation such as the interaction with peripheral components or devices.

The computer-readable program instructions of the present disclosure may be assembler instructions, instruction set architecture (ISA) instructions, machine instructions, machine-dependent instructions, microcode, firmware instructions, state-setting data, or source code or object code written in any combination of one or more programming languages, including an object-oriented programming language, and conventional procedural programming languages. The computer-readable program instructions may execute entirely on a computing device as a stand-alone software package, or partly on a first computing device and partly on a second computing device remote from the first computing device. In the latter scenario, the second, remote computing device may be connected to the first computing device through any type of network, including a cellular network for example based on 3GPP, a local area network (LAN) or a wide area network (WAN).

The UE 200 may include the processor 208 that may include a hardware device with processing capabilities. The processor 208 may include at least one of a general-purpose processor, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or other programmable logic device. Examples of the general-purpose processor include, but are not limited to, a microprocessor, any conventional processor, a controller, a microcontroller, or a state machine. In some embodiments, the processor 208 may be implemented using a combination of devices (e.g., a combination of a DSP and a microprocessor, multiple microprocessors, one or more microprocessors in conjunction with a DSP core, or any other such configuration). The processor 208 may receive downlink signals or sidelink signals from the transceiver 204 and further process the signals. The processor 208 may also receive data packets from the transceiver 204 and further process the packets. In some embodiments, the processor 208 may be configured to operate a memory using a memory controller. In some embodiments, the memory controller may be integrated into the processor 208. The processor 208 may be configured to execute computer-readable instructions stored in a memory (e.g., the memory 206) to cause the UE 200 to perform various functions.

The UE 200 may include a global positioning system (GPS) 210. The GPS 210 may be used for enabling location-based services or other services based on a geographical position of the UE 200 and/or for synchronization among UEs. The GPS 210 may receive global navigation satellite systems (GNSS) signals from a single satellite or a plurality of satellite signals via the antenna 202 and provide a geographical position of the UE 200 (e.g., coordinates of the UE 200).

The UE 200 may include an input/output (I/O) device 212 that may be used to communicate a result of signal processing and computation to a user or another device. The I/O device 212 may include a user interface including a display and an input device to transmit a user command to the processor 208. The display may be configured to display a status of signal reception at the UE 200, the data stored at the memory 206, a status of signal processing, and a result of computation, etc. The display may include, but is not limited to, a cathode ray tube (CRT), a liquid crystal display (LCD), a light-emitting diode (LED), a gas plasma display, a touch screen, or other image projection devices for displaying information to a user. The input device may be any type of computer hardware equipment used to receive data and control signals from a user. The input device may include, but is not limited to, a keyboard, a mouse, a scanner, a digital camera, a joystick, a trackball, cursor direction keys, a touchscreen monitor, or audio/video commanders, etc.

The UE 200 may further include a machine interface 214, such as an electrical bus that connects the transceiver 204, the memory 206, the processor 208, the GPS 210, and the I/O device 212.

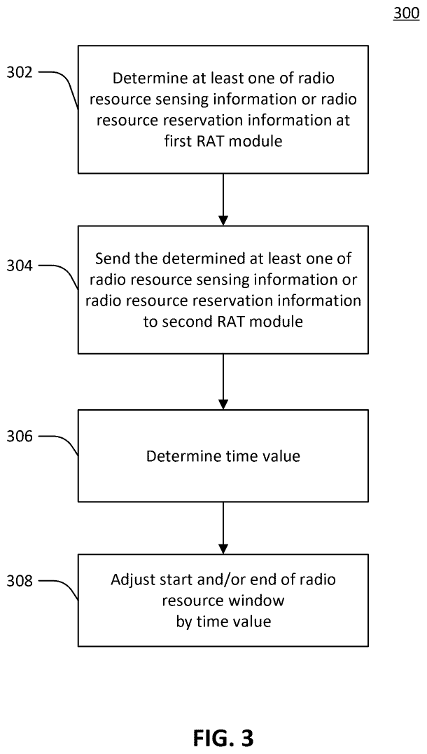

In some embodiments, the UE 200 may be configured to or programmed for sidelink communications. The processor 208 may be configured to execute the instructions stored in the memory 206 to perform a method for adjusting at least one of a start or an end of a radio resource window by the UE 200, such as the method 300 described in connection with FIG. 3.

In an embodiment where the UE 200 is a Type A UE, the UE 200 may include a first radio access technology (RAT 1) module 220 in communication with the bus 214 and a second radio access technology (RAT 2) module 222 in communication with the bus 214. In some embodiments, RAT 1 module 220 may be configured to implement a first RAT, for example, LTE. In some embodiments, RAT 2 module 222 may be configured to implement a second RAT, different from the first RAT, for example, NR. It is noted that the types of RATs implemented by the RAT modules 220, 222 are not limited to LTE and NR. The RAT modules 220, 222 may implement any type of RAT without changing the principles of operation of the embodiments described herein.

In an embodiment where the UE 200 is a Type B UE or a Type C UE, the UE 200 may include only one RAT module (e.g., RAT 1 module 220). RAT 1 module 220 may implement any type of RAT, e.g., LTE, NR, or other type of RAT. In FIG. 2, RAT 2 module 222 is shown in dashed outline to indicate that it may not be included in some embodiments.

### Resource Selection

For the example of 3GPP NR Sidelink, 3GPP TS 38.214 subclause 8.1.4 describes how the UE (at the physical layer) determines a subset of resources, to be reported to higher layers for PSSCH resource selection in SL resource allocation mode 2, which is autonomous resource allocation by the UE in NR Sidelink, based on a pool of resources provided by the network.

For initial resource selection, the formula 0≤T₁≤T^{SL}_{proc,1} is used to determine the start of a radio resource selection window. The time value T₁ (as a number of slots) defines the duration time after which the resource selection window starts, i.e., the resource selection window starts at a time associated with slot T₁, where T^{SL}_{proc,1} is the maximum value that T₁ can take.

For resource re-evaluation, the time value T₃ defines the time (in relation to the start of the UE transmission, given by t) at which re-evaluation is performed (following sensing results received at a slot number≤t−T₃) to determine whether resource reselection is needed or not. In other words, resource re-evaluation is performed at least at a time associated with slot number t−T₃. It is up to UE implementation to perform resource re-evaluation before t−T₃ or after t−T₃ but before t.

For resource selection and resource reselection in LTE and NR co-channel coexistence, it is implied that the LTE SL module provides resource sensing information and resource reservation information to the NR SL module. The NR SL module uses this information for its resource selection and resource reselection. As the LTE SL module and the NR SL module may be part of two different hardware modules, possibly located at different parts of a vehicle (for example), transfer of information from one module to another module may incur some delay. Therefore, the NR SL timing requirements may not be valid due to the transmission delay. One or more aspects of the present disclosure address these deficiencies by allowing or facilitating adjustment of the T₁ and T₃ values, so that these values account for the potential transmission delay from one SL module to another SL module. If this transmission delay is not considered, there may be a mismatch on the sensing window, selection window, and reselection window affecting the NR SL side that may lead to degraded performance. Mismatch may happen between the LTE and NR windows.

In some embodiments, a new parameter is provided to the UE. The UE adds (by arithmetic addition) the value of this parameter to the value that is assessed for T^{SL}_{proc,1}. Since the maximum value of T₁ is defined by T^{SL}_{proc,1}, adjusting T^{SL}_{proc,1} updates the maximum T₁ value for the resource selection. For the resource reselection, since it is stated in TS 38.214 that “T₃ is equal to T^{SL}_{proc,1},” adjusting T^{SL}_{proc,1} also updates T₃.

The new parameter to be added to T^{SL}_{proc,1} may have any name, for example, T^{SL}_{Delta,1}, TDelta, or T₁Delta. For ease of discussion, the name “TDelta” will be primarily used in this disclosure to indicate this parameter. TDelta may be expressed in any time value, for example, as a number of frames, a number of sub-frames, and/or a number of timeslots.

TDelta may be provided by the network to the UE, for example via the NR Radio Resource Control (RRC) protocol in 3GPP TS 38.331. It may be provided via another radio access technology, for example, via the LTE (E-UTRA) RRC protocol in 3GPP TS 36.331. It may be provided in a dedicated point-to-point message (for example, via the NR RRCReconfiguration message or the E-UTRA RRCConnectionReconfiguration message) or in a broadcast message (for example, via an RRC System Information Broadcast (SIB) message).

FIG. 3 is a flowchart of a method 300 for adjusting at least one of a start or an end of a radio resource window at a UE in a communication network, consistent with some embodiments of the present disclosure. At least one of radio resource sensing information or radio resource reservation information is determined at a first RAT module (step 302). One example of the first RAT module is the RAT 1 module 220 shown in the embodiment of FIG. 2. The first RAT module is configured to implement a first RAT, e.g., LTE. The determined at least one of radio resource sensing information or radio resource reservation information is sent to a second RAT module (step 304). One example of the second RAT module is the RAT 2 module 222 shown in the embodiment of FIG. 2. The second RAT module is configured to implement a second RAT, e.g., NR. It is noted that the type of RAT implemented by the first RAT module and the second RAT module are not limited to LTE and NR. The first RAT module and the second RAT module may implement any type of RAT without changing the principles of operation of the embodiments described herein. As noted above in connection with FIG. 2, a Type A UE may include both the first RAT module (e.g., RAT 1 module 220) and the second RAT module (e.g., RAT 2 module 222). A Type B UE or a Type C UE may include the first RAT module (e.g., RAT 1 module 220), but not any additional RAT module, such as the second RAT module.

The UE determines a time value (step 306) and adjusts at least one of the start or the end of a radio resource window by the time value (step 308). The radio resource window may include any one or more of a radio resource sensing window, a radio resource selection window, or a radio resource reselection window. In some embodiments, the time value may be determined based on a type of the radio resource window. A set of preferred radio resources may be constructed using the radio resource window and may involve excluding at least one radio resource.

In some embodiments, the second RAT module receives a difference parameter and the time value is determined based on the difference parameter. The second RAT module may receive the difference parameter from the first RAT module or from the communication network via any one of: fifth generation new radio resource control signaling, another RAT, a dedicated point-to-point message, or a broadcast message.

In some embodiments, the difference parameter is a positive value and the time value is a positive value. The start or the end of the radio resource window may be adjusted by adding the time value to the start or the end of the radio resource window, thereby shortening or lengthening the radio resource window.

In some embodiments, the difference parameter is a negative value and the time value is a negative value. The start or the end of the radio resource window may be adjusted by subtracting the time value from the start or the end of the radio resource window, thereby lengthening or shortening the radio resource window.

In some embodiments, the time value is determined based on a difference parameter retrieved from a memory of the UE wherein the difference parameter is configured or preconfigured. In some embodiments, the time value is retrieved from a memory of the UE wherein the time value is configured or preconfigured. In some embodiments, the time value is determined based on a sub-carrier spacing of the first RAT or a sub-carrier spacing of the second RAT.

In some embodiments, the method 300 includes receiving an enable signal by the UE from the communication network and determining whether to perform the adjusting based on the enable signal.

In some embodiments, the method 300 includes transmitting sidelink control information to another UE, wherein the sidelink control information indicates to the other UE that the UE adjusted the radio resource window.

In some embodiments, the method 300 includes estimating a communication delay between the first RAT module and the second RAT module. The time value may be determined based on the estimated communication delay. For example, the time value may be determined to be a fixed value based on the estimated communication delay being a non-zero value. As another example, the time value may be determined to be a fixed value based on the estimated communication delay exceeding a threshold.

In some embodiments, the UE includes both the first RAT module and the second RAT module. In other embodiments, a first UE includes the first RAT module and a second UE includes the second RAT module.

In some embodiments, TDelta may be pre-configured in the UE. It may be hard-coded in the UE, for example, because a fixed value may be used. It may be introduced in a 3GPP Technical Specification as part of an embodiment of this disclosure. In the example of NR Sidelink, this may for example be introduced in 3GPP TS 38.214 as part of embodiments of this application. It may also be pre-configured in the UE via the USIM (Universal Subscriber Identity Module), for example, using the USIM Toolkit controlled by the home network operator (carrier, Public Land Mobile Network (PLMN)).

In other embodiments, only a Type A UE applies TDelta. A UE which is not Type A would ignore TDelta if received (i.e., the UE may treat it as if TDelta=0).

In other embodiments, applying TDelta is determined and/or performed by the second module of a Type A UE.

In other embodiments, a UE may apply TDelta independently from receiving radio resource sensing information and/or radio resource reservation information. For example, the second module of a Type A UE may apply TDelta independently from receiving radio resource sensing information and/or radio resource reservation from the first module.

In other embodiments, the use of TDelta (i.e., whether using TDelta is enabled or disabled) is controlled by the network, which may be received by the UE via a message (for example, an RRC message).

In other embodiments, more than one value of TDelta is provided, and different types of UEs apply different values of TDelta (for example, a Type A UE may apply a first value of TDelta while a non-Type A UE may apply a second value of TDelta different than the first value of TDelta). In other embodiments, the network provides different values for TDelta based on the type of the UE (for example, Type A versus not Type A) or depending on UE capabilities. The UE may provide information on its type to the network to allow the network to provide the correct value of TDelta (for example, the UE may indicate to the network if it is Type A or not).

In other embodiments, TDelta may apply only to T₁. In other embodiments, TDelta may apply only to T₃. In other embodiments, one or more values of TDelta may apply to T₁, and one or more values of TDelta may apply to T₃.

In other embodiments, TDelta may be a function of sub-carrier spacings that the two Radio Access Technologies (RATs) use (e.g., LTE and NR). For example, different values of TDelta may be set for different sub-carrier spacings that two RATs use. This is because different sub-carrier spacings may have different delays in the inter-module communication.

In other embodiments, TDelta may reflect negative values. Table 1 below provides an example of TDelta as provided to the UE, with mix of positive and negative values:

TABLE 1
TDelta Interpretation

| TDelta parameter value | Interpretation/Meaning (in slots) |
|---|---|
| 0 | −2 |
| 1 | −1 |
| 2 | 0 |
| 3 | +1 |
| 4 | +2 |
| 5 | +3 |
| 6 | 0 |
| 7 | 0 |

In other embodiments, the formula in 3GPP TS 38.214 for defining the sensing window may use a subtraction operation instead of an addition operation. In embodiments where subtraction is used, providing a positive value of TDelta leads to a reduction of T^{SL}_{proc,1}, T₁, and/or T₃, while providing a negative value of TDelta leads to an increase of T^{SL}_{proc,1}, T₁, and/or T₃.

Although the example of NR was chosen in the descriptions above, the embodiments in the present disclosure are not limited to NR and may apply to other RAT(s), such as 6G or LTE/E-UTRA.

In other embodiments, TDelta applies if a specific RAT is assessed as present (i.e., detected). The specific RAT may be LTE (E-UTRA), NR, or 6G for example. In other embodiments, more than one specific RAT may be detected as a condition for using TDelta. A new UE measurement may be introduced to determine whether an LTE RAT is detected or not. In one embodiment, the new measurement is performed at the physical layer and reported to the RRC layer. In another embodiment, the measurement is performed directly at the RRC layer and is reported to the physical layer. This new measurement may be based on long-term averaged measurements, for example. This may apply to measured values such as RSRP and/or RSSI, for example.

As an example, the term “relaxed timers” may be used to indicate that these timers are extended. In other words, T₁ and T₃ when “relaxed” correspond to a longer time duration. In other embodiments, the term “relaxed timer” reflects a modified value of the timer that may be a decreased value.

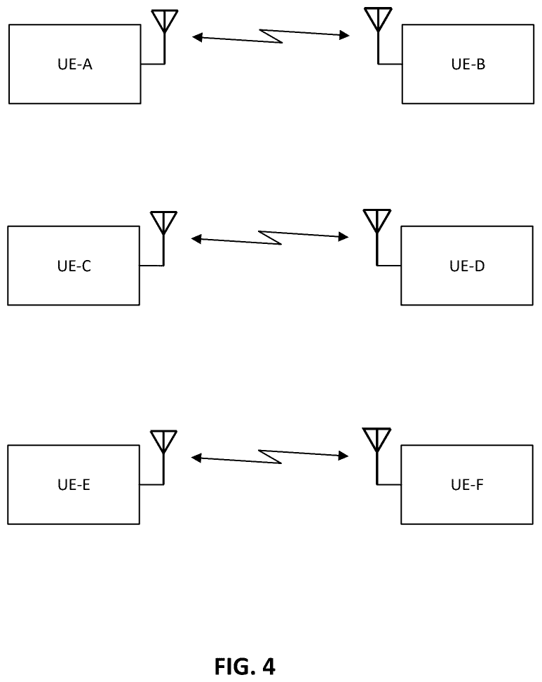

FIG. 4 is a schematic diagram illustrating different UEs in communication with each other, consistent with some embodiments of the present disclosure. As shown in FIG. 4, UE-A is in communication with UE-B, UE-C is in communication with UE-D, and UE-E is in communication with UE-F. Each pair of UEs in communication with each other is in a same communication network. For example, UE-A and UE-B may be in a first communication network, UE-C and UE-D may be in a second communication network, and UE-E and UE-F may be in a third communication network. The different pairs of UEs may be in the same communication network or in different communication networks. Continuing the preceding example, the first communication network, the second communication network, and the third communication network may be the same communication network or may be separate communication networks. In one embodiment, when a UE (e.g., UE-C) applies the proposed relaxed timers (T₁ and T₃) in its resource selection and resource reselection/re-evaluation procedure, it may indicate that it used the relaxed timers via a flag in the sidelink control information (SCI) so that other UEs (e.g., UE-D) may become aware that any transmission and resource reservation information from UE-C is under these relaxed timers. In some embodiments, UE-C may include the value of TDelta in the SCI sent to UE-D.

In another embodiment, the other UEs (e.g., UE-D), upon detecting that UE-C is applying the proposed relaxed timers (T₁ and T₃) in its resource selection and resource reselection/re-evaluation procedure (e.g., via a flag in the SCI), take that information into account when performing their own resource selection. For example, when UE-D is forming its candidate resource set, it may exclude resources that if selected to transmit the UE-D's resource reservation information (i.e., a resource reservation that points to a resource reserved by UE-D) that will not allow enough time for UE-C to react (i.e., due to the relaxed T₃ timer) and perform resource reselection to avoid the collision between the UE-C and UE-D's transmissions.

In another embodiment, a UE (e.g., UE-E) that needs to receive information on the LTE SL module and needs relaxation to the T₁ and/or T₃ timers may not have relaxed timers (e.g., the relaxed timers are not configured in UE-E) but adds an indication, e.g., via a flag in the SCI, that it will spend extra time before it is finished with its resource reselection/reevaluation. Upon receipt of this SCI, the receiving UE (e.g., UE-F), when forming its candidate resource set, may exclude some resources corresponding to an estimated delay (i.e., the “extra time” referred to above) that if selected to transmit the UE-F's resource reservation information (i.e., a resource reservation that points to a resource reserved by UE-F) that will not allow enough time for UE-E to react (i.e., due to the expected delay) and perform resource reselection to reduce the probability of the collision between the UE-E and UE-F's transmissions. This estimated delay may be based on TDelta if available at UE-F, or on distance or round-trip-times between the UEs.

In another embodiment, UE-B (i.e., the UE applying the relaxed timers) when requesting inter-UE coordination support from UE-A, indicates that it is applying the relaxed timers in its resource selection and/or resource reselection and/or sensing. In other words, the inter-UE coordination request message includes an indication that UE-B is applying the relaxed timers. The value of TDelta, the relaxed timers, and/or the difference parameters may be provided in the inter-UE coordination message instead, in addition to, or as part of this indication.

In another embodiment, UE-A (i.e., the UE performing the inter-UE coordination support) upon receiving the inter-UE coordination request message with the indication that UE-B is applying relaxed timers to its resource allocation then takes into account when constructing the set of preferred resources and non-preferred resources. For example, when constructing the set of preferred resources, UE-A may include resources that respect the T₁ timer, i.e., resources no earlier than T₁ plus the actual time when the inter-UE coordination message is sent back to UE-B. For example, when constructing the set of non-preferred resources, UE-A includes resources which may potentially be selected by UE-B, excluding all resources which may otherwise be usable by UE-B due to the relaxed timers.

In another embodiment, when UE-B performs its transmission, it includes a future resource reservation and adds an indication that it supports inter-UE coordination scheme 2 (e.g., the Conflict information receiver flag in the first stage SCI is set at one) and an indication that is operating with the proposed relaxed timers. The value of TDelta, the relaxed timers, and/or the difference parameters may be provided instead of, in addition to, or as part of this indication.

In another embodiment, UE-A detects a transmission from UE-B that includes a future resource reservation, an indication that it supports inter-UE coordination scheme 2 (e.g., the Conflict information receiver flag in the first stage SCI is set at one), and an indication that is operating with the proposed relaxed timers. Upon this detection and upon the determination that the future resource reservation indicated by UE-B will collide with a resource reserved by another UE (which was received by UE-A either before UE-B's reservation or after), then UE-A transmits the collision indication if this may be received by UE-B in time enough to trigger the resource reselection. In other words, the collision indication needs to be received by UE-B at the latest in a slot occurring at or before t-T₃_relaxed, where t is the slot where the resource reserved by UE-B will occur.

In another embodiment, UE-C estimates the delay between its two modules (e.g., LTE and NR modules) and this estimation is used to set the relaxed timer limit. The estimation may be done by one of the following methods:
a) time from requesting sensing information from one RAT until the response is provided;
b) comparing the time from receiving a sensing information message to the latest subframe ending time of which was represented in the sensing information message;
c) comparing the time from the end of a subframe until the reception of a sensing report; or
d) other means provided by the interface between the two modules.

In some embodiments, if the estimation determines that there is a delay between the two modules (i.e., the estimated delay is a non-zero value), then the fixed value of TDelta as described elsewhere in this disclosure may be applied. For example, a flag may be set to indicate that TDelta is to be applied. In other embodiments, if the estimation determines that there is a delay between the two modules and the delay exceeds a threshold value, then the fixed value of TDelta may be applied. For example, a flag may be set to indicate that TDelta is to be applied.

Any of the embodiments described herein may be used simultaneously or in combination. The combination of various embodiments may be controlled by one or more parameters with the same embodiments as described herein with regards to providing those parameters to the UE. In another embodiment, any embodiment described herein may apply conditionally to the UE being in a Sidelink co-existence setting.

Any embodiment described herein may apply conditionally to the UE operating in the same resource pool or carrier frequency as the one being detected.

Any of the embodiments described in this disclosure may apply to 3GPP Sidelink. This may, for example, apply to Release 18 NR Sidelink and/or Release 18 LTE-NR Sidelink co-existence (for example, for Sidelink in Unlicensed access). However, the embodiments described in this disclosure are not restricted to this technology and may apply to other wireless communication technologies, for example and not limited to, Digital Enhanced Cordless Telecommunications/Digital European Cordless Telecommunications (DECT) or IEEE 802.11, for example, Wi-Fi.

As used in this disclosure, use of the term “or” in a list of items indicates an inclusive list. The list of items may be prefaced by a phrase such as “at least one of” or “one or more of.” For example, a list of at least one of A, B, or C includes A or B or C or AB (i.e., A and B) or AC or BC or ABC (i.e., A and B and C). Also, as used in this disclosure, prefacing a list of conditions with the phrase “based on” shall not be construed as “based only on” the set of conditions and rather shall be construed as “based at least in part on” the set of conditions. For example, an outcome described as “based on condition A” may be based on both a condition A and a condition B without departing from the scope of this disclosure.

In this specification the terms “comprise,” “include,” or “contain” may be used interchangeably and have the same meaning and are to be construed as inclusive and open-ending. The terms “comprise,” “include,” or “contain” may be used before a list of elements and indicate that at least all of the listed elements within the list exist but other elements that are not in the list may also be present. For example, if A comprises B and C, both {B, C} and {B, C, D} are within the scope of A.

The present disclosure, in connection with the accompanied drawings, describes example configurations that are not representative of all the examples that may be implemented or all configurations that are within the scope of this disclosure. The term “exemplary” should not be construed as “preferred” or “advantageous compared to other examples” but rather “an illustration, an instance, or an example.” By reading this disclosure, including the description of the embodiments and the drawings, it will be appreciated by a person of ordinary skill in the art that the technology disclosed herein may be implemented using alternative embodiments. The person of ordinary skill in the art would appreciate that the embodiments, or certain features of the embodiments described herein, may be combined to arrive at yet other embodiments for practicing the technology described in the present disclosure. Thus, the disclosure is not limited to the examples and designs described herein but is to be accorded the broadest scope consistent with the principles and novel features disclosed herein.

The flowcharts and block diagrams in the figures illustrate examples of the architecture, functionality, and operation of possible implementations of systems, methods, and devices according to various embodiments. It should be noted that, in some alternative implementations, the functions noted in blocks may occur out of the order noted in the figures. For example, two blocks shown in succession may, in fact, be executed substantially concurrently, or the blocks may sometimes be executed in the reverse order, depending upon the functionality involved. Likewise, additional steps may be included in such methods, and certain steps may be omitted or combined, in methods consistent with various embodiments.

It is understood that the described embodiments are not mutually exclusive, and elements, components, materials, or steps described in connection with one example embodiment may be combined with, or eliminated from, other embodiments in suitable ways to accomplish desired design objectives.

Reference herein to “some embodiments” or “some exemplary embodiments” means that a particular feature, structure, or characteristic described in connection with the embodiment can be included in at least one embodiment. The appearance of the phrases “one embodiment,” “some embodiments,” or “another embodiment” in various places in the present disclosure do not all necessarily refer to the same embodiment, nor are separate or alternative embodiments necessarily mutually exclusive of other embodiments.

Additionally, the articles “a” and “an” as used in the present disclosure and the appended claims should generally be construed to mean “one or more” unless specified otherwise or clear from context to be directed to a singular form.

Unless explicitly stated otherwise, each numerical value and range should be interpreted as being approximate as if the word “about” or “approximately” preceded the value of the value or range.

Although the elements in the following method claims, if any, are recited in a particular sequence, unless the claim recitations otherwise imply a particular sequence for implementing some or all of those elements, those elements are not necessarily intended to be limited to being implemented in that particular sequence.

It is appreciated that certain features of the present disclosure, which are, for clarity, described in the context of separate embodiments, may also be provided in combination in a single embodiment. Conversely, various features of the specification, which are, for brevity, described in the context of a single embodiment, may also be provided separately or in any suitable subcombination or as suitable in any other described embodiment of the specification. Certain features described in the context of various embodiments are not essential features of those embodiments, unless noted as such.

It will be further understood that various modifications, alternatives and variations in the details, materials, and arrangements of the parts which have been described and illustrated to explain the nature of described embodiments may be made by those skilled in the art without departing from the scope of this disclosure. Accordingly, the following claims embrace all such alternatives, modifications, and variations that fall within the terms of the claims.
Clause 1. A method for adjusting at least one of a start or an end of a radio resource window at a user equipment (UE) in a communication network, the method comprising:
determining at least one of radio resource sensing information or radio resource reservation information at a first radio access technology (RAT) module, wherein the first RAT module is configured to implement a first RAT;
sending the determined at least one of radio resource sensing information or radio resource reservation information from the first RAT module to a second RAT module, wherein the second RAT module is configured to implement a second RAT, the second RAT being different from the first RAT;
determining a time value; and
adjusting at least one of the start or the end of the radio resource window by the time value.
Clause 2. The method of clause 1, further comprising:
receiving a difference parameter at the second RAT module,
wherein the time value is determined based on the difference parameter.
Clause 3. The method of clause 2, wherein the receiving includes receiving the difference parameter at the second RAT module from the first RAT module.
Clause 4. The method of clause 2, wherein the receiving includes receiving the difference parameter at the second RAT module from the communication network.
Clause 5. The method of clause 2, wherein the receiving includes receiving the difference parameter at the second RAT module from the communication network via any one of: fifth generation new radio resource control signaling, another RAT, a dedicated point-to-point message, or a broadcast message.
Clause 6. The method of clause 2, wherein:
the difference parameter is a positive value;
the time value is a positive value; and
adjusting at least one of the start or the end of the radio resource window includes adding the time value to the start or the end of the radio resource window, thereby shortening or lengthening the radio resource window.
Clause 7. The method of clause 2, wherein:
the difference parameter is a negative value;
the time value is a negative value; and
adjusting at least one of the start or the end of the radio resource window includes subtracting the time value from the start or the end of the radio resource window, thereby lengthening or shortening the radio resource window.
Clause 8. The method of clause 1, wherein the time value is determined based on a difference parameter retrieved from a memory of the UE wherein the difference parameter is configured or preconfigured.
Clause 9. The method of clause 1, wherein the time value is determined based on a sub-carrier spacing of the first RAT or a sub-carrier spacing of the second RAT.
Clause 10. The method of clause 1, wherein the radio resource window is one of: a radio resource selection window, a radio resource re-selection window, or a radio resource sensing window.
Clause 11. The method of clause 10, wherein determining the time value comprises determining the time value based on a type of the radio resource window.
Clause 12. The method of clause 1, further comprising:
constructing a set of preferred radio resources using the radio resource window.
Clause 13. The method of clause 12, wherein constructing the set of preferred radio resources excludes at least one radio resource.
Clause 14. The method of clause 1, further comprising:
receiving an enable signal by the UE from the communication network; and
determining whether to perform the adjusting based on the enable signal.
Clause 15. The method of clause 1, further comprising:
transmitting sidelink control information to another UE, wherein the sidelink control information indicates to the other UE that the UE adjusted the radio resource window.
Clause 16. The method of clause 1, further comprising:
estimating a communication delay between the first RAT module and the second RAT module,
wherein the time value is determined based on the estimated communication delay.
Clause 17. The method of clause 16, wherein the time value is determined to be a fixed value based on the estimated communication delay being a non-zero value.
Clause 18. The method of clause 16, wherein the time value is determined to be a fixed value based on the estimated communication delay exceeding a threshold.
Clause 19. The method of clause 1, wherein the UE includes both the first RAT module and the second RAT module.
Clause 20. The method of clause 1, wherein a first UE includes the first RAT module and a second UE includes the second RAT module.
Clause 21. A user equipment (UE) for adjusting at least one of a start or an end of a radio resource window by the UE, the UE comprising:
a memory configured to store instructions; and
a processor configured to execute the instructions stored in the memory to:
   determine at least one of radio resource sensing information or radio resource reservation information at a first radio access technology (RAT) module, wherein the first RAT module is configured to implement a first RAT;
   send the determined at least one of radio resource sensing information or radio resource reservation information from the first RAT module to a second RAT module, wherein the second RAT module is configured to implement a second RAT, the second RAT being different from the first RAT;
   determine a time value; and
   adjust at least one of the start or the end of the resource window by the time value.
Clause 22. The UE of clause 21, wherein the processor is further configured to:
receive a difference parameter at the second RAT module; and
determine the time value based on the difference parameter.
Clause 23. The UE of clause 22, wherein processor is further configured to:
receive the difference parameter at the second RAT module from the first RAT module.
Clause 24. The UE of clause 22, wherein the processor is further configured to:
receive the difference parameter at the second RAT module from the communication network.
Clause 25. The UE of clause 22, wherein the processor is further configured to:
receive the difference parameter at the second RAT module from the communication network via any one of: fifth generation new radio resource control signaling, another RAT, a dedicated point-to-point message, or a broadcast message.
Clause 26. The UE of clause 22, wherein:
the difference parameter is a positive value;
the time value is a positive value; and
the processor is further configured to adjust at least one of the start or the end of the radio resource window by adding the time value to the start or the end of the radio resource window, thereby shortening or lengthening the radio resource window.
Clause 27. The UE of clause 22, wherein:
the difference parameter is a negative value;
the time value is a negative value; and
the processor is further configured to adjust at least one of the start or the end of the radio resource window by subtracting the time value from the start or the end of the radio resource window, thereby lengthening or shortening the radio resource window.
Clause 28. The UE of clause 21, wherein the processor is further configured to:
retrieve a difference parameter from a memory of the UE, wherein the difference parameter is configured or preconfigured; and
determine the time value based on a difference parameter.
Clause 29. The UE of clause 21, wherein the processor is further configured to:
determine the time value based on a sub-carrier spacing of the first RAT or a sub-carrier spacing of the second RAT.
Clause 30. The UE of clause 21, wherein the radio resource window is one of: a radio resource selection window, a radio resource re-selection window, or a radio resource sensing window.
Clause 31. The UE of clause 30, wherein the processor is further configured to:
determine the time value based on a type of the radio resource window.
Clause 32. The UE of clause 21, wherein the processor is further configured to:
construct a set of preferred radio resources using the radio resource window.
Clause 33. The UE of clause 32, wherein the processor is further configured to:
construct the set of preferred radio resources by excluding at least one radio resource.
Clause 34. The UE of clause 21, wherein the processor is further configured to:
receive an enable signal by the UE from the communication network; and
determine whether to perform the adjusting based on the enable signal.
Clause 35. The UE of clause 21, wherein the processor is further configured to:
transmit sidelink control information to another UE, wherein the sidelink control information indicates to the other UE that the UE adjusted the radio resource window.
Clause 36. The UE of clause 21, wherein the processor is further configured to:
estimate a communication delay between the first RAT module and the second RAT module; and
determine the time value based on the estimated communication delay.
Clause 37. The UE of clause 36, wherein the processor is further configured to:
determine the time value to be a fixed value based on the estimated communication delay being a non-zero value.
Clause 38. The UE of clause 36, wherein the processor is further configured to:
determine the time value to be a fixed value based on the estimated communication delay exceeding a threshold.
Clause 39. The UE of clause 21, wherein the UE includes both the first RAT module and the second RAT module.
Clause 40. The UE of clause 21, wherein the UE includes the first RAT module and a second UE includes the second RAT module.
Clause 41. A non-transitory computer-readable medium storing instructions that are executable by one or more processors of a user equipment (UE) in a communication network to perform a method for adjusting at least one of a start or an end of a radio resource window by the UE, the method comprising:
determining at least one of radio resource sensing information or radio resource reservation information at a first radio access technology (RAT) module, wherein the first RAT module is configured to implement a first RAT;
sending the determined at least one of radio resource sensing information or radio resource reservation information from the first RAT module to a second RAT module, wherein the second RAT module is configured to implement a second RAT, the second RAT being different from the first RAT;
determining a time value; and
adjusting at least one of the start or the end of the resource window by the time value.

1. A method for adjusting at least one of a start or an end of a radio resource window at a user equipment (UE) in a communication network, the method comprising:
determining at least one of radio resource sensing information or radio resource reservation information at a first radio access technology (RAT) module, wherein the first RAT module is configured to implement a first RAT;
sending the determined at least one of radio resource sensing information or radio resource reservation information from the first RAT module to a second RAT module, wherein the second RAT module is configured to implement a second RAT, the second RAT being different from the first RAT;
determining a time value; and
adjusting at least one of the start or the end of the radio resource window by the time value.

2. The method of claim 1, further comprising:
receiving a difference parameter at the second RAT module,
wherein the time value is determined based on the difference parameter.

3. The method of claim 2, wherein the receiving includes receiving the difference parameter at the second RAT module from the first RAT module.

4. The method of claim 2, wherein the receiving includes receiving the difference parameter at the second RAT module from the communication network.

5. The method of claim 2, wherein the receiving includes receiving the difference parameter at the second RAT module from the communication network via any one of: fifth generation new radio resource control signaling, another RAT, a dedicated point-to-point message, or a broadcast message.

6. The method of claim 2, wherein:
the difference parameter is a positive value;
the time value is a positive value; and
adjusting at least one of the start or the end of the radio resource window includes adding the time value to the start or the end of the radio resource window, thereby shortening or lengthening the radio resource window.

7. The method of claim 2, wherein:
the difference parameter is a negative value;
the time value is a negative value; and
adjusting at least one of the start or the end of the radio resource window includes subtracting the time value from the start or the end of the radio resource window, thereby lengthening or shortening the radio resource window.

8. The method of claim 1, wherein the time value is determined based on a difference parameter retrieved from a memory of the UE wherein the difference parameter is configured or preconfigured.

9. The method of claim 1, wherein the time value is determined based on a sub-carrier spacing of the first RAT or a sub-carrier spacing of the second RAT.

10. The method of claim 1, wherein the radio resource window is one of: a radio resource selection window, a radio resource re-selection window, or a radio resource sensing window.

11. The method of claim 10, wherein determining the time value comprises determining the time value based on a type of the radio resource window.

12. The method of claim 1, further comprising:
constructing a set of preferred radio resources using the radio resource window.

13. The method of claim 12, wherein constructing the set of preferred radio resources excludes at least one radio resource.

14. The method of claim 1, further comprising:
receiving an enable signal by the UE from the communication network; and
determining whether to perform the adjusting based on the enable signal.

15. The method of claim 1, further comprising:
transmitting sidelink control information to another UE, wherein the sidelink control information indicates to the other UE that the UE adjusted the radio resource window.

16. The method of claim 1, further comprising:
estimating a communication delay between the first RAT module and the second RAT module,
wherein the time value is determined based on the estimated communication delay.

17. The method of claim 16, wherein the time value is determined to be a fixed value based on the estimated communication delay being a non-zero value.

18. The method of claim 16, wherein the time value is determined to be a fixed value based on the estimated communication delay exceeding a threshold.

19. The method of claim 1, wherein the UE includes both the first RAT module and the second RAT module.

20. The method of claim 1, wherein a first UE includes the first RAT module and a second UE includes the second RAT module.
